(19) United States
(12) Patent Application Publication
(10) Pub. No.: US 2025/0036397 A1
(43) Pub. Date: Jan. 30, 2025

(54) SYSTEM AND METHOD FOR MANAGING PLACEMENT OF SOFTWARE COMPONENTS IN A COMPUTING ENVIRONMENT BASED ON USER PREFERENCES

(71) Applicant: VMWARE, INC>, Palo Alto, CA (US)

(72) Inventors: RAVI KUMAR REDDY KOTTAPALLI, Banqalore (IN); Sudarshana KANDACHAR SRIDHARA RAO, Banqalore (IN); Venkata Swamy Babu BUDUMURU, Vishakhapatnam (IN); Dinesh Kumar KAMALAKANNAN, Banqalore (IN); Madhu Bindiganavalae Manjunath, Banqalore (IN)

(21) Appl. No.: 18/381,188

(22) Filed: Oct. 18, 2023

(30) Foreign Application Priority Data
Jul. 24, 2023 (IN) 202341049840

(51) Int. Cl. G06F 8/70

(52) U.S. Cl. CPC G06F 8/70

(57) ABSTRACT

System and computer-implemented method for managing placements of software components in host computers of a computing environment uses placement rules for a software component, which are automatically generated based on user input received at a managed entity in the computing environment. The placement rules are transmitted to a management entity that controls placement and migration of software components in the computing environment using a resource scheduler. The placement rules are then provided to the resource scheduler to be applied to the software component for placement operations.

### RELATED APPLICATIONS

Benefit is claimed under 35 U.S.C. 119(a)-(d) to Foreign application Ser. No. 202341049840 filed in India entitled “SYSTEM AND METHOD FOR MANAGING PLACEMENT OF SOFTWARE COMPONENTS IN A COMPUTING ENVIRONMENT BASED ON USER PREFERENCES”, on Jul. 24, 2023, by VMware, Inc., which is herein incorporated in its entirety by reference for all purposes.

### BACKGROUND

Software-defined data centers (SDDCs) may be deployed in any computing environment. These SDDCs may be deployed in an on-premises computing environment and/or in a public cloud environment, where each SDDC may include at least one management entity that manage one or more SDDC entities (“managed entities”).

An SDDC may include a resource scheduler that provides resource scheduling and load balancing services for the SDDC. Thus, a resource scheduler may control the initial and subsequent placement of software components in the SDDC. However, in some implementations, software components may be deployed by a managed entity in an SDDC based on user preferences. In these implementations, the desired placement of the software components that are deployed by the managed entity may conflict with the recommended placement of the software components made by the resource scheduler. Thus, there is a need to resolve this conflict to place the managed components in the desired locations based on the user preferences.

### SUMMARY

System and computer-implemented method for managing placements of software components in host computers of a computing environment uses placement rules for a software component, which are automatically generated based on user input received at a managed entity in the computing environment. The placement rules are transmitted to a management entity that controls placement and migration of software components in the computing environment using a resource scheduler. The placement rules are then provided to the resource scheduler to be applied to the software component for placement operations.

A computer-implemented method for managing placements of software components in host computers of a computing environment in accordance with an embodiment of the invention comprises receiving user input for a software component at a managed entity in the computing environment, the user input containing user-selected preferences relating to placement of the software component in a host computer of the computing environment, automatically generating placement rules for the software component based on the user input, transmitting the placement rules to a management entity that controls placement and migration of software components in the computing environment using a resource scheduler, and providing the placement rules for the software component to the resource scheduler by the management entity to be applied to the software component for placement operations. In some embodiments, the steps of this method are performed when program instructions contained in a computer-readable storage medium are executed by one or more processors.

A system in accordance with an embodiment of the invention comprises memory and at least one processor configured to receive user input for a software component at a managed entity in the computing environment, the user input containing user-selected preferences relating to placement of the software component in a host computer of the computing environment, automatically generate placement rules for the software component based on the user input, transmit the placement rules to a management entity that controls placement and migration of software components in the computing environment using a resource scheduler, and provide the placement rules for the software component to the resource scheduler by the management entity to be applied to the software component for placement operations.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 is a block diagram of a computing environment in which embodiments of the invention may be implemented.

FIG. 2 shows an example of a graphic user interface (GUI) that may be used by a managed entity in the computing environment in accordance with an embodiment of the invention.

FIG. 3 illustrates a process of automatically generating resource scheduler (RS) placement rules for a software component being deployed in the computing environment by a managed entity in accordance with an embodiment of the invention.

FIG. 4 shows components of a dynamic policy engine in a managed entity in accordance with an embodiment of the invention.

FIG. 5 illustrates a process of automatically generating RS placement rules for a software component in the computing environment based on user-selected host network, host security and host application priority preferences via a managed entity in accordance with an embodiment of the invention.

FIG. 6 is a process flow diagram of a computer-implemented method for managing placements of software components in host computers of a computing environment in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

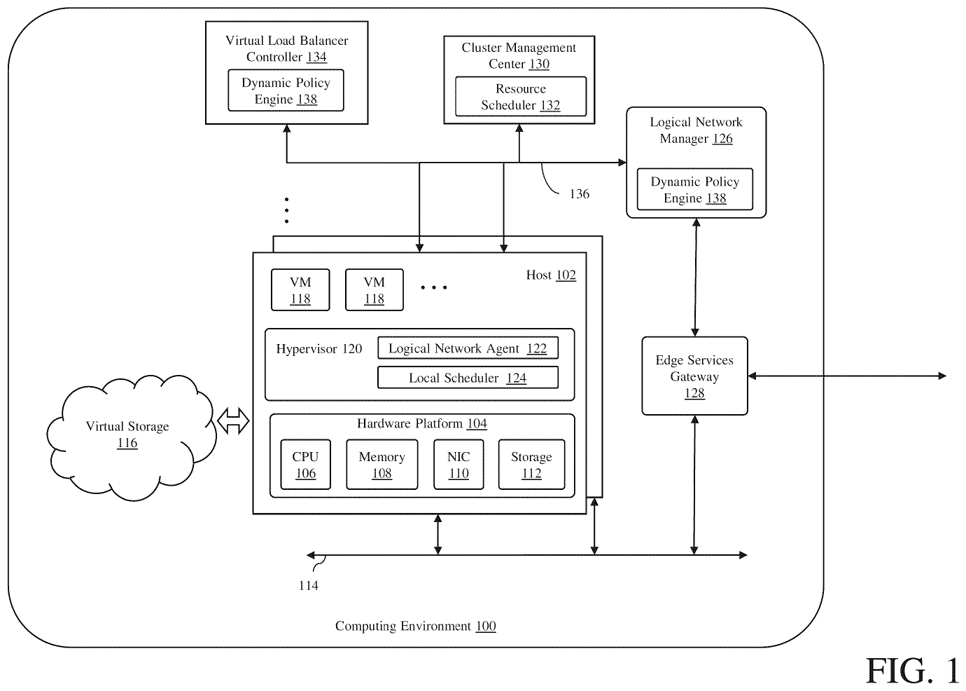

FIG. 1 shows a computing environment 100 in which embodiments of the invention can be implemented. The computing environment 100 can be any environment that provides compute, network and storage resources, such as a software-defined data center (SDDC). The computing environment may be a private cloud computing environment, e.g., an on-prem SDDC, a public cloud computing environment, e.g., an SDDC in a public cloud, or a hybrid (private and public) cloud computing environment. The computing environment 100 will be described herein as an SDDC.

As shown in FIG. 1, the SDDC 100 includes a number of host computers (“hosts”) 102. The hosts 102 may be constructed on a server grade hardware platform 104, such as an x86 architecture platform. As shown, the hardware platform 104 of each host 102 may include conventional components of a computer, such as one or more processors (e.g., CPUs) 106, system memory 108, a network interface 110, and storage 112. The processor 106 can be any type of a processor commonly used in servers. The memory 108 is volatile memory used for retrieving programs and processing data. The memory 108 may include, for example, one or more random access memory (RAM) modules. The network interface 110 enables the host 102 to communicate with other devices that are inside or outside of the SDDC 100 via a communication network, such as a network 114. The network interface 110 may be one or more network adapters, also referred to as network interface cards (NICs). The storage 112 represents one or more local storage devices (e.g., one or more hard disks, flash memory modules, solid state disks and/or optical disks), which may be used as part of a virtual storage 116 (e.g., virtual storage area network.

Each host 102 may be configured to provide a virtualization layer that abstracts processor, memory, storage and networking resources of the hardware platform 104 into virtual computing instances (VCIs) 118 that run concurrently on the same host. As used herein, the term “virtual computing instance” refers to any software processing entity that can run on a computer system, such as a software application, a software process, a virtual machine or a virtual container. A virtual machine is an emulation of a physical computer system in the form of a software computer that, like a physical computer, can run an operating system and applications. A virtual machine may be comprised of a set of specification and configuration files and is backed by the physical resources of the physical host computer. A virtual machine may have virtual devices that provide the same functionality as physical hardware and have additional benefits in terms of portability, manageability, and security. An example of a virtual machine is the virtual machine created using VMware vSphere® solution made commercially available from VMware, Inc of Palo Alto, California. A virtual container is a package that relies on virtual isolation to deploy and run applications that access a shared operating system (OS) kernel. An example of a virtual container is the virtual container created using a Docker engine made available by Docker, Inc. In this disclosure, the virtual computing instances will be described as being virtual machines, although embodiments of the invention described herein are not limited to virtual machines (VMs).

In the illustrated embodiment, the VCIs in the form of VMs 118 are provided by host virtualization software 120, which is referred to herein as a hypervisor, that enables sharing of the hardware resources of the host by the VMs. One example of the hypervisor 120 that may be used in an embodiment described herein is a VMware ESXi™ hypervisor provided as part of the VMware vSphere® solution made commercially available from VMware, Inc. The hypervisor 120 may run on top of the operating system of the host or directly on hardware components of the host. For other types of VCIs, the host may include other virtualization software platforms to support those VCIs, such as Docker virtualization platform to support “containers”. Although embodiments of the inventions may involve other types of VCIs, various embodiments of the invention are described herein as involving VMs.

In the illustrated embodiment, the hypervisor 120 includes a logical network (LN) agent 122, which operates to provide logical networking capabilities, also referred to as “software-defined networking”. Each logical network may include software managed and implemented network services, such as bridging, L3 routing. L2 switching, network address translation (NAT), and firewall capabilities, to support one or more logical overlay networks in the SDDC 100. The logical network agent 122 may receive configuration information from a logical network manager 126 (which may include a control plane cluster) and, based on this information, populates forwarding, firewall and/or other action tables for dropping or directing packets between the VMs 118 in the host 102, other VMs on other hosts, and/or other devices outside of the SDDC 100. Collectively, the logical network agent 122, together with other logical network agents on other hosts, according to their forwarding/routing tables, implement isolated overlay networks that can connect arbitrarily selected VMs with each other. Each VM may be arbitrarily assigned a particular logical network in a manner that decouples the overlay network topology from the underlying physical network. Generally, this is achieved by encapsulating packets at a source host and decapsulating packets at a destination host so that VMs on the source and destination can communicate without regard to the underlying physical network topology. In a particular implementation, the logical network agent 122 may include a Virtual Extensible Local Area Network (VXLAN) Tunnel End Point or VTEP that operates to execute operations with respect to encapsulation and decapsulation of packets to support a VXLAN backed overlay network. In alternate implementations, VTEPs support other tunneling protocols, such as stateless transport tunneling (STT), Network Virtualization using Generic Routing Encapsulation (NVGRE), or Geneve, instead of, or in addition to, VXLAN.

The hypervisor 120 may also include a local scheduler 124. The local scheduler 124 operates as a part of a distributed resource management system, which is controlled by a resource scheduler 132, as described below. The distributed resource management system provides various resource management features for the SDDC 100, including placement of software components, e.g., the VMs 118, in the hosts 102 of the SDDC 100 using various placement rules.

As noted above, the SDDC 100 also includes the logical network manager 126 (which may include a control plane cluster), which operates with the logical network agents 122 in the hosts 102 to manage and control logical overlay networks in the SDDC. In some embodiments, the SDDC 100 may include multiple logical network managers that provide the logical overlay networks of the SDDC. Logical overlay networks comprise logical network devices and connections that are mapped to physical networking resources, e.g., switches and routers, in a manner analogous to the manner in which other physical resources as compute and storage are virtualized. In an embodiment, the logical network manager 126 has access to information regarding physical components and logical overlay network components in the SDDC 100. With the physical and logical overlay network information, the logical network manager 126 is able to map logical network configurations to the physical network components that convey, route, and filter physical traffic in the SDDC 100. In a particular implementation, the logical network manager 126 is a VMware NSX® Manager™ product running on any computer, such as one of the hosts 102 or VMs 118 in the SDDC 100.

The SDDC 100 also includes one or more edge services gateways 128 to control network traffic into and out of the SDDC. In a particular implementation, the edge services gateway 128 is VMware NSX® Edge™ product made available from VMware, Inc. running on any computer, such as one of the hosts 102 or VMs 118 in the SDDC 100. The logical network manager(s) 126 and the edge services gateway(s) 128 are part of a logical network platform, which supports the software-defined networking in the SDDC 100.

The SDDC 100 further includes a cluster management center 130, which operates to manage and monitor one or more clusters of hosts 116. A cluster of hosts is a logical grouping of hosts, which share the compute, network and/or storage resources of the cluster. The cluster management center 130 may be configured to allow an administrator to selectively create clusters of hosts, add hosts to the clusters, delete hosts from the clusters and delete the clusters. The cluster management center 130 may further be configured to monitor the current configurations of the hosts 102 in the clusters and the VMs 118 running on the hosts. The monitored configurations may include hardware and/or software configurations of each of the hosts 102. The monitored configurations may also include VM hosting information, i.e., which VMs are hosted or running on which hosts. In order to manage the hosts 102 and the VMs 118 in the clusters, the cluster management center 130 support or execute various operations. In an embodiment, the cluster management center 130 is a computer program that resides and executes in a computer system, such as one of the hosts 102, or in one of the VMs 118 running on the hosts.

As illustrated, the cluster management center 130 includes a resource scheduler 132, which operates with the local schedulers 124 of the hosts 102 as part of the distributed resource management system to provide resource scheduling and load balancing solution for the SDDC 100. The resource scheduler 132 is configured to work on a cluster of hosts and to provide resource management capabilities, such as load balancing and placement for software components, such as VMs. The resource scheduler 132 is also configured to enforce user-defined resource allocation policies at the cluster level, while working with system-level constraints. Thus, the resource scheduler 132 controls the operations for initial placements of VMs, e.g., in the hosts 102, and subsequent VM migrations in the SDDC, e.g., between the hosts 102, using various placement rules for the VMs. These placement rules used by the resource scheduler to perform these placement operations are referred to herein as resource scheduler (RS) placement rules.

In an embodiment, the main goal of the resource scheduler 132 is to ensure that VMs and their applications are always getting the compute resources that they need to run efficiently. In other words, the resource scheduler 132 strives to keep the VMs running properly. This is achieved by ensuring that newly powered-on VMs get all the required resources soon after they are powered on, and the resource utilization is always balanced across the cluster.

During initial placement and load balancing, the resource scheduler 132 generates placement and migration recommendations, respectively. The resource scheduler 132 can then apply these recommendations automatically, or provide them to the user for manual executions. In an embodiment, the resource scheduler 132 has three levels of automation. The first level is a fully automated level, where the resource scheduler 132 applies both initial placement and load balancing recommendations automatically. The second level is a partially automated level, where the resource scheduler 132 applies recommendations only for initial placement. The third level is a manual level, where the user manually applies both initial placement and load balancing recommendations.

In an embodiment, the resource scheduler 132 provides many tools for the user to customize the VMs and workloads according to specific use cases. In a particular implementation, the resource scheduler 132 is VMware vSphere® Distributed Resource Scheduler™ (DRS) module and the cluster management center 130 is the VMware vCenter Server® software made available from VMware, Inc. Thus, in this particular implementation, the RS placement rules used by the resource scheduler 132 are DRS rules used by the DRS module.

The cluster management center 130 is the main managing component of the SDDC 100. Thus, the cluster management center 130 can be viewed as a management entity for the SDDC 100, which can deploy and manage software components, e.g., VMs, in the SDDC. However, there may be other entities running in the SDDC that can deploy and manage software components, but also managed by the cluster management center 130. These entities will be referred to herein as managed entities. As an example, the logical network manager 126 may be a managed entity. In some embodiments, the SDDC 100 may include additional managed entities, such as a virtual load balancer controller 134, which may be a VMware NSX® Advanced Load Balancer (AVI) controller, which deploys datapath or load balancing components in the form of VMs.

In the illustrated embodiment, the management components of the SDDC 100, such as the logical network manager 126, the edge services gateway 128, the cluster management center 130 and the virtual load balancer controller 134, communicate using a management network 136, which may be separate from the network 114, which are used by the hosts 102 and the VMs 118 on the hosts. In an embodiment, at least some of the management components of the SDDC 100 may be implemented in one or more virtual computing instance, e.g., VMs 118, running in the SDDC 100. In some embodiments, there may be multiple instances of the logical network manager 126 and the edge services gateway 128 that are deployed in multiple VMs running in the SDDC.

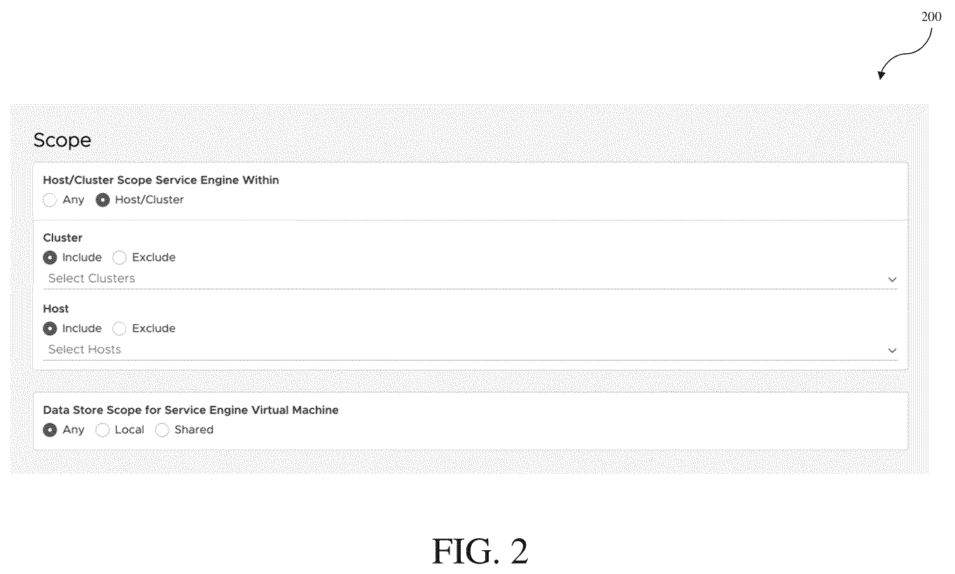

The managed entities, such as the virtual load balancer controller 134, may allow users to select placement options for software components in the SDDC 100 using a graphic user interface (GUI). An example of a GUI 200 that may be provided by a managed entity in the SDDC is illustrated in FIG. 2. As shown in FIG. 2, the GUI 200 provides options for host and/or cluster selections, as well as a data store, for placement of a software component in the SDDC.

However, in a conventional SDDC, as soon as a software component is deployed in the SDDC with options selected using a GUI, such as the GUI 200, the resource scheduler of a cluster management center in that SDDC will ignore the user-selected options and make migration recommendations, which may override the placement options selected by the user.

In order to solve this problem, each of the managed entities in the SDDC 100, such as the logical network manager 126 and the virtual load balancer controller 134, includes a dynamic policy engine 138. The dynamic policy engine is a software module that is configured to automatically generate RS placement rules when user selects options for software components being deployed in the SDDC 100 using a GUI, such as the GUI 200 shown in FIG. 2. As an example, if a user selects “myhost” for the host option, “MyCluster” for the cluster option and “MyDS” for the datastore option for the component “AVI Load Balancer”, the following rule may be automatically generated by the dynamic policy engine.

| Rule ID: | Component | Host | Cluster | Datastore |
|---|---|---|---|---|
| X | AVI Load Balancer | myhost | MyCluster | MyDS |

The generated RS placement rules are compatible with the rules used by the resource scheduler 132. That is, the generated RS placement rules satisfy the same requirements, such as format and terms, as the rules used by the resource scheduler 132. The generated RS placement rules are then sent to the cluster management center 130, which are provided to the resource scheduler 132 to make placement recommendations. In an embodiment, the generate RS placement rules are added to a library of RS rules for the resource scheduler 132 to use when making placement and migration recommendations for software components in the SDDC.

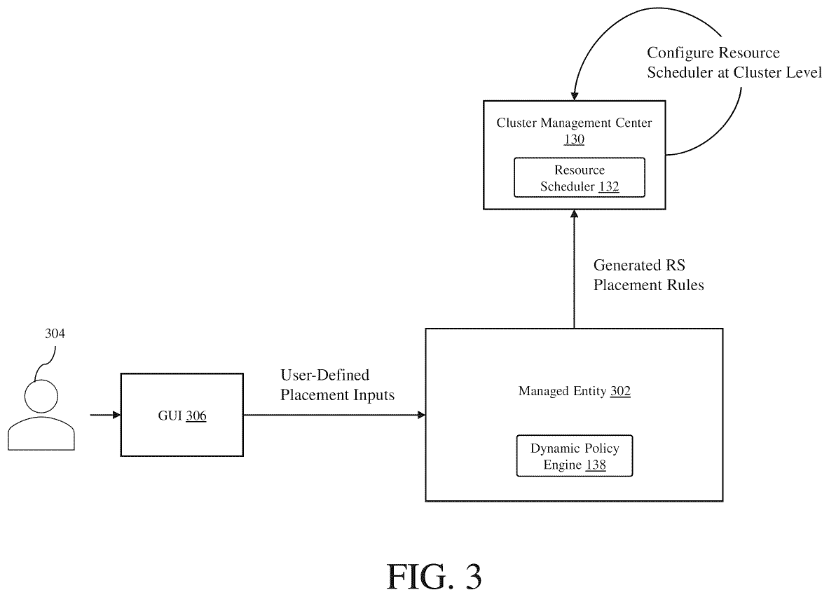

FIG. 3 illustrates a process of automatically generating RS placement rules for a software component being deployed in the SDDC 100 by a managed entity in accordance with an embodiment of the invention. As shown in FIG. 3, user-defined placement inputs for a software component are entered into a managed entity 302, e.g., the load balancer controller 134, by a user 304 using a GUI 306, which is provided by the managed entity. These user-defined placement inputs may be option selections and/or user-entered values or names. The user-defined inputs may be related to host, cluster and data storage options, as illustrated in FIG. 2.

The user-defined placement inputs are then processed by the dynamic policy engine 138 of the managed entity 302 to automatically generate RS placement rules for the software component using the user-defined placement inputs. The RS placement rules for the software component are transmitted from the dynamic policy engine 138 to the cluster management center 130, where the resource scheduler 132 is configured by the cluster management center at a cluster level so that the RS placement rules from the dynamic policy engine 138 are applied by the resource scheduler 132 for the software component in order to comply with the user preferences for the software component.

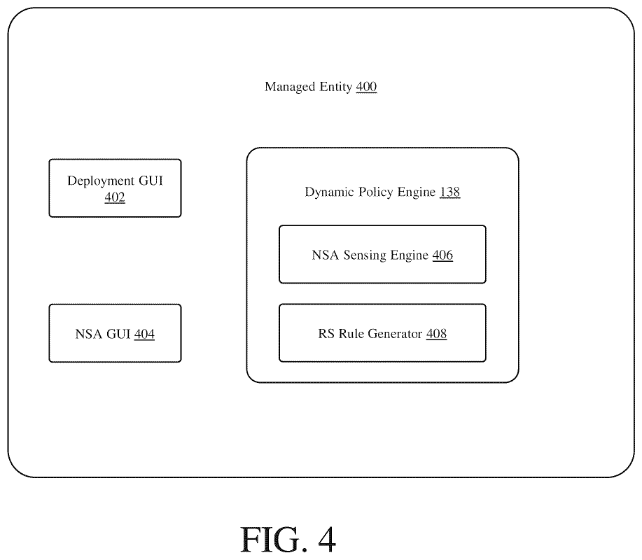

In an embodiment, the dynamic policy engine 138 of a managed entity, e.g., the load balancer controller 134, may also automatically generate RS placement rules based on host network, host security and host application parameters, which may be entered by a user. An example of the dynamic policy engine 138 in accordance with an embodiment of the invention is illustrated in FIG. 4. As shown in FIG. 4, the dynamic policy engine 138 provides a deployment GUI 402 and a network, security and application (NSA) GUI 404, which can be used to receive user inputs. The dynamic policy engine 138 also includes an NSA sensing engine 406 and an RS rule generator 408.

The deployment GUI 402 may be same or similar to the GUI 200 shown in FIG. 2. Thus, the deployment GUI 402 may allow a user to select host, cluster and/or data storage options or preferences for software components being deployed in the SDDC 100. The deployment GUI 402 may allow a user to modify the host, cluster and/or data storage options or preferences for the software components after deployment. The deployment GUI 402 may be a web-based or application-provided GUI.

The NSA GUI 404 provides options or preferences related to host network, host security and host application priority for a user to select or define. As an example, the NSA GUI 404 may provide options for a user to select bandwidth, delay and/or jitter for placement of software components in the hosts 102 in the SDDC 100. The NSA GUI 404 may also provide options for a user to select security features, e.g., a particular type of graphic processing unit (GPU), for placement of software components in the hosts in the SDDC. The NSA GUI 404 may also provide options for a user to select an application priority, e.g., a particular type of applications, for placement of software components in the hosts in the SDDC. The NSA GUI 404 may be a web-based or application-provided GUI. In an embodiment, the NSA GUI 404 may be integrated into the deployment GUI 402.

The NSA sensing engine 406 is configured to sense the hosts 102 in the SDDC 100 to determine which hosts in the SDDC satisfy the host network, host security and/or host application priority preferences selected by the user. Thus, network metrics, such as bandwidth, delay and jitter, of the hosts in the SDDC are retrieved or recorded if one or more network preferences are selected by the user. Similarly, security information of the hosts in the SDDC is retrieved if security preference is selected by the user. Also, application information of the hosts in the SDDC is retrieved if application priority preference is selected by the user. In some embodiments, the information that is retrieved by the NSA sensing engine 406 may be provided by the hosts (e.g., the host virtualization software 120) or by the cluster management center 130.

The RS rule generator 408 is configured to convert user-selected and/or user-defined placement options for software components to RS placement rules, which are transmitted to the cluster management center 130 to be applied by the resource scheduler 132. In addition, the RS rule generator 408 is also configured to generate RS placement rules based on host network, host security and/or host application parameters, which are entered by a user using the NSA GUI 404. These RS placement rules based on the host network, host security and/or host application parameters are also transmitted to the cluster management center 130 to be applied by the resource scheduler 132.

In an embodiment, the RS rule generator 408 is configured to maintain RS policy tables. When one or more placement options for a software component are entered by a user, an RS policy table is created by the RS rule generator 408 based on the user inputs. As noted above, the placement options may be related to host, cluster and/or data store for a software component. Thus, any one or more options related to host, cluster and data store may be entered by a user. The placement options may also be related to host network, host security and/or host application preferences. Thus, one of the host network, host security and host application preferences may be entered by a user. Alternatively, any combination of host network, host security and host application preferences may be entered by a user.

For each user input with respect to placement options for a software component, an RS policy table is created by the RS rule generator 408. In an embodiment, the contents of each RS policy table may include (1) a table identifier (ID), (2) name of managed entity, (3) name of management entity, (4) user options (e.g., host, cluster and/or data store), (5) network preference, (6) security preference, (7) application preference, and (8) RS placement rules. In addition, any related values for user options or preferences may be included in the RS policy table. For example, threshold limits for network performance preferences may be included in the RS policy table.

An example of an RS policy table in accordance with an embodiment of the invention is shown below.

| | | | | | | | |
|---|---|---|---|---|---|---|---|
| Table | Managed | Management | User | Net- | Secu- | Appli- | RS |
| Id | Entity | Entity | options | work | rity | cation | rules |

| | | | | | |
|---|---|---|---|---|---|
| aa | NSX-T | vCenter IP | Yes | No | Yes |
| | AVI | | | | |

In this example, “NSX-T AVI” has been selected by a user as the managed entity, which is managed by the management entity “vCenter”. In addition, in this example, network and application parameters have been selected by the user. Thus, using these user-selected information, RS placement rules are generated by the RS rule generator 408, which may be included in the “RS rules” field in the RS policy table.

As illustrated in FIG. 1, the dynamic policy engine 138 is a software component that can be reside in any managed entity. For example, the dynamic policy engine 138 can be part of an SDDC manager of a VMware Cloud Foundation™ (VCF) platform, an AVI controller of an NSX-T Advanced Load Balancer platform, or a part of NSX-T managers of NSX-T data centers. In some embodiments, there may be more than one dynamic policy engine 138 in an SDDC.

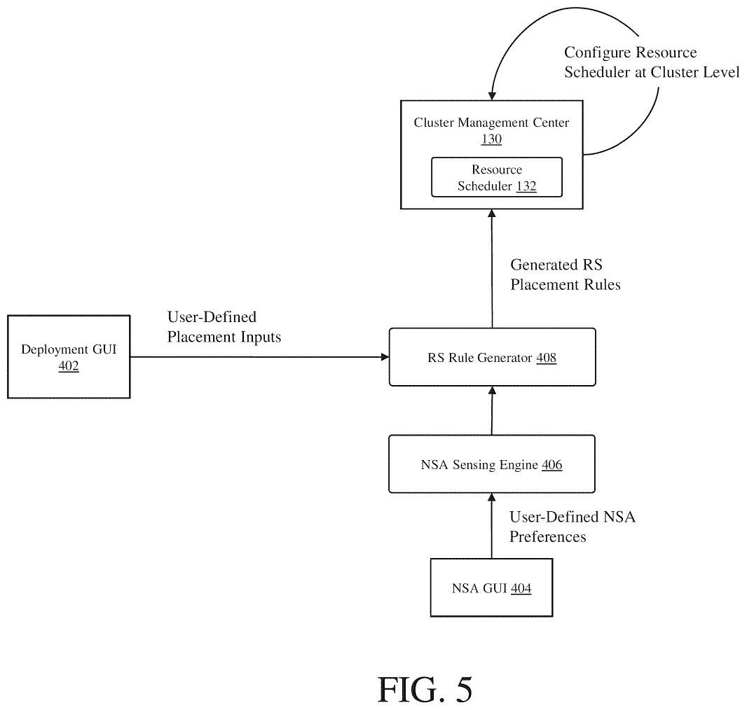

FIG. 5 illustrates a process of automatically generating RS placement rules for a software component in the computing environment based on user-selected host network, host security and host application priority preferences via a managed entity in accordance with an embodiment of the invention. As shown in FIG. 5, the user preferences for a software component with respect to host network, host security and/or host application are entered into the managed entity by a user using the NSA GUI 404. As an example, the host network preferences may include network performance preferences, such as bandwidth, delay and jitter for the hosts 102 in the SDDC 100. The security preferences may include security features of the hosts. The application preferences may include application priorities in the hosts.

In response to the user-entered host network, host security and/or host application preferences, the hosts 102 in the SDDC 100 are sensed by the NSA sensing engine 406 of the dynamic policy engine 138 to determine which hosts in the SDDC satisfy the network, security and/or application preferences. Thus, network metrics, such as bandwidth, delay and jitter, of the hosts in the SDDC are retrieved or recorded if one or more network preferences are selected by the user. Similarly, security information of the hosts in the SDDC is retrieved if security preference is selected by the user. Also, application information of the hosts in the SDDC is retrieved if application preference is selected by the user.

The information retrieved by the NSA sensing engine 406 is used by the RS rule generator 408 to automatically generate RS placement rules for the software component based on the user-entered host network, host security and/or host application preferences. As part of this operation, an RS policy table may be created by the RS rule generator 408, which may be save in storage accessible by the dynamic policy engine 138. The generated RS placement rules for the software component are then transmitted to the cluster management center 130, where these rules are applied by the resource scheduler 132 for the software component.

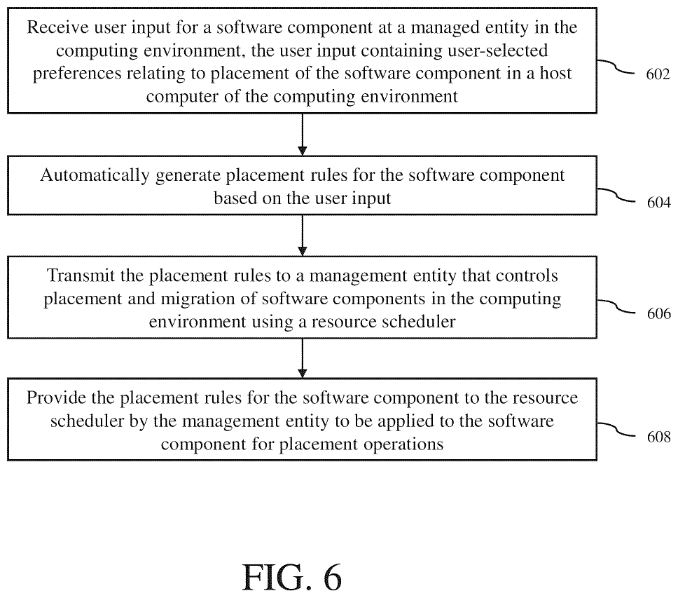

A computer-implemented method for managing placements of software components in host computers of a computing environment, such as the SDDC 100, in accordance with an embodiment of the invention is described with reference to a process flow diagram of FIG. 6. At block 602, user input for a software component is received at a managed entity in the computing environment. The user input contains user-selected preferences relating to placement of the software component in a host computer of the computing environment. At block 604, placement rules for the software component are automatically generated based on the user input. At block 606, the placement rules are transmitted to a management entity that controls placement and migration of software components in the computing environment using a resource scheduler. At block 608, the placement rules for the software component are provided to the resource scheduler by the management entity to be applied to the software component for placement operations.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disc, and an optical disc. Current examples of optical discs include a compact disc with read only memory (CD-ROM), a compact disc with read/write (CD-R/W), a digital video disc (DVD), and a Blu-ray disc.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer-implemented method for managing placements of software components in host computers of a computing environment, the method comprising:
receiving user input for a software component at a managed entity in the computing environment, the user input containing user-selected preferences relating to placement of the software component in a host computer of the computing environment;
automatically generating placement rules for the software component based on the user input;
transmitting the placement rules to a management entity that controls placement and migration of software components in the computing environment using a resource scheduler; and
providing the placement rules for the software component to the resource scheduler by the management entity to be applied to the software component for placement operations.

2. The method of claim 1, wherein the management entity is a cluster management center that is configured to create at least one cluster of host computers in the computing environment and wherein the resource scheduler is a module in the cluster management center.

3. The method of claim 1, wherein the user-selected preferences include at least one of host, cluster and data store options for the software component.

4. The method of claim 1, wherein the user-selected preferences include at least one of host network performance, host security and host application priority preferences for the software component.

5. The method of claim 4, wherein the host network performance of the user-selected preferences includes at least one of bandwidth, delay and jitter.

6. The method of claim 4, further comprising sensing the host computers in the computing environment to retrieve information with respect to the user-selected preferences of at least one of the host network performance, the host security and the host application priority.

7. The method of claim 1, wherein the software component is a virtual machine.

8. A non-transitory computer-readable storage medium containing program instructions for managing placements of software components in host computers of a computing environment, wherein execution of the program instructions by one or more processors causes the one or more processors to perform steps comprising:
receiving user input for a software component at a managed entity in the computing environment, the user input containing user-selected preferences relating to placement of the software component in a host computer of the computing environment;
automatically generating placement rules for the software component based on the user input;
transmitting the placement rules to a management entity that controls placement and migration of software components in the computing environment using a resource scheduler; and
providing the placement rules for the software component to the resource scheduler by the management entity to be applied to the software component for placement operations.

9. The non-transitory computer-readable storage medium of claim 8, wherein the management entity is a cluster management center that is configured to create at least one cluster of host computers in the computing environment and wherein the resource scheduler is a module in the cluster management center.

10. The non-transitory computer-readable storage medium of claim 8, wherein the user-selected preferences include at least one of host, cluster and data store options for the software component.

11. The non-transitory computer-readable storage medium of claim 8, wherein the user-selected preferences include at least one of host network performance, host security and host application priority preferences for the software component.

12. The non-transitory computer-readable storage medium of claim 11, wherein the host network performance of the user-selected preferences includes at least one of bandwidth, delay and jitter.

13. The non-transitory computer-readable storage medium of claim 11, wherein the steps further comprise sensing the host computers in the computing environment to retrieve information with respect to the user-selected preferences of at least one of the host network performance, the host security and the host application priority.

14. The non-transitory computer-readable storage medium of claim 8, wherein the software component is a virtual machine.

15. A system comprising:
memory; and
at least one processor configured to:
receive user input for a software component at a managed entity in the computing environment, the user input containing user-selected preferences relating to placement of the software component in a host computer of a computing environment;
automatically generate placement rules for the software component based on the user input;
transmit the placement rules to a management entity that controls placement and migration of software components in the computing environment using a resource scheduler; and
provide the placement rules for the software component to the resource scheduler by the management entity to be applied to the software component for placement operations.

16. The system of claim 15, wherein the management entity is a cluster management center that is configured to create at least one cluster of host computers in the computing environment and wherein the resource scheduler is a module in the cluster management center.

17. The system of claim 15, wherein the user-selected preferences include at least one of host, cluster and data store options for the software component.

18. The system of claim 15, wherein the user-selected preferences include at least one of host network performance, host security and host application priority preferences for the software component.

19. The system of claim 18, wherein the host network performance of the user-selected preferences includes at least one of bandwidth, delay and jitter.

20. The system of claim 18, wherein the at least one processor is configured to sense the host computers in the computing environment to retrieve information with respect to the user-selected preferences of at least one of the host network performance, the host security and the host application priority.
